(19) United States
(12) Patent Application Publication
(10) Pub. No.: US 2025/0174414 A1
(43) Pub. Date: May 29, 2025

(54) HYBRID ENERGY STORAGE DEVICE

(71) Applicant: SAMHWA CAPACITOR CO., LTD., Yongin-si (KR)

(72) Inventors: Young Joo OH, Yongin-si (KR); Jung Rag YOON, Yongin-si (KR); Jong Kyu LEE, Yongin-si (KR); Won Su LEE, Yongin-si (KR)

(21) Appl. No.: 18/894,757

(22) Filed: Sep. 24, 2024

(30) Foreign Application Priority Data
Nov. 23, 2023 (KR) 10-2023-0164776

(51) Int. Cl. H01G 11/08; H01G 11/10; H01G 11/74; H01G 11/78; H01M 4/485; H01M 4/505

(52) U.S. Cl. CPC H01G 11/08; H01G 11/10; H01G 11/74; H01G 11/78; H01M 4/485; H01M 4/505

(57) ABSTRACT

Provided is a hybrid energy storage device including a surface-mounted capacitor having a pair of external electrodes formed on one side and the other side thereof, a lead-type lithium titanium oxide (LTO) battery having a pair of lead terminals connected thereto, an insulating case having a circular insertion groove formed on one side thereof and a pair of metal connection patterns spaced apart from each other inside the circular insertion groove, and a pair of external terminal plates arranged on one side and the other side of the insulating case, respectively, and having either side thereof connected to the metal connection pattern.

### TECHNICAL FIELD

The present invention relates to a hybrid energy storage device, and more particularly, to a hybrid energy storage device capable of easily mounting lithium titanium oxide (LTO) batteries and capacitors connected in parallel with each other by connecting the capacitors to the LTO batteries in parallel and assembling the LTO batteries with capacitors in one case.

### BACKGROUND ART

LTO batteries have a spinel structure, and thus have low risk of explosion and firing due to high thermal runaway temperature because there is no change in volume in a process of charging and discharging lithium ions. Like lithium ion batteries (LIBs), in the case of the LTO batteries, a ternary system is used for a positive electrode, but a compound of LTO (e.g., Li₄Ti₅O₁₂) is used for a negative electrode.

As disclosed in Korean Patent Publication No. 10-2151074 (referred to as Patent Document 1), technologies for improving electrical characteristics of LTO batteries are being developed.

The Patent Document 1 relates to a secondary battery, which includes a positive electrode, a negative electrode, and a separator. The positive electrode includes a first current collector and a LiNi_{0.5}Mn_{1.5}O₄ (LNMO) electrode formed on the surface of the first current collector. A material of the LNMO electrode is formed by mixing 88 to 94 wt % of LiNi_{0.5}Mn_{1.5}O₄, 1 to 2 wt % of rare earth elements, and 5 to 10 wt % of activated carbon, and the rare earth elements are added by selecting one or more of dysprosium (Dy), yttrium (Y), europium (Eu), and praseodymium (Pr). The activated carbon of the LNMO electrode uses chemical activated carbon.

The negative electrode is spaced apart from the positive electrode and includes a second current collector and an LTO electrode formed on a surface of the second current collector. A material of the LTO electrode is formed by mixing 90 to 99 wt % of Li₄Ti₅O₁₂ metal oxide coating powder and 1 to 10 wt % of activated carbon, and the Li₄Ti₅O₁₂ metal oxide coating powder is formed by applying a metal oxide to surfaces of Li₄Ti₅O₁₂ powder. One of TiO₂ and Nb₂O₅ is selected and used as the metal oxide, and activated carbon of the LTO electrode is formed by mixing 20 to 80 wt % of chemical activated carbon and 20 to 80 wt % of steam activated carbon.

The separator is arranged between the positive electrode and the negative electrode, and is assembled in a case in a state in which the separator is arranged between the positive electrode and the negative electrode to assemble a secondary battery, that is, an LTO battery.

The LTO battery, as disclosed in Patent Document 1, has a problem in that explosion or fire does not occur even in a high-temperature or high-pressure situation, and may be operated in a wide temperature range, but has weak equivalent series resistance (ESR) or surge characteristics.

### SUMMARY OF THE INVENTION

### Technical Problem

To solve the above-described problems, an objective of the present invention is to provide a hybrid energy storage device capable of easily mounting LTO batteries and capacitors connected in parallel with each other by connecting the capacitors to the LTO batteries in parallel with each other and assembling the LTO batteries with the capacitors in one case.

Another objective of the present invention is to provide a hybrid energy storage device that may be used as a charge pump by compensating for power through capacitors during an instantaneous high power discharge to prevent output power from being lowered due to equivalent series resistance (ESR) characteristics of an LTO battery, thereby enabling instantaneous high power discharge.

Still another object of the present invention is to provide a complex energy storage device which may expand a range of use temperatures while having sufficient energy storage density by using an LTO battery, and may be used even in a harsh environment such as an Internet of Things (IoT) by improving surge characteristics through capacitors.

### Technical Solution

According to an aspect of the present invention, there is provided a hybrid energy storage device including a surface-mounted capacitor having a pair of external electrodes formed on one side and the other side thereof, a lead-type lithium titanium oxide (LTO) battery having a pair of lead terminals connected thereto, an insulating case having a circular insertion groove formed on one side thereof and a pair of metal connection patterns spaced apart from each other inside the circular insertion groove, and a pair of external terminal plates arranged on one side and the other side of the insulating case, respectively, and having either side thereof connected to the metal connection pattern, wherein the surface-mounted capacitor is arranged inside the circular insertion groove so that each of the pair of external electrodes are connected to the metal connection pattern, and the lead-type LTO battery is inserted into the circular insertion groove so that the pair of lead terminals are connected to the external terminal plates, respectively.

### BRIEF DESCRIPTION OF THE DRAWINGS

FIG. 1 is a perspective view of a hybrid energy storage device according to an embodiment.

FIG. 2 is a side view of the hybrid energy storage device shown in FIG. 1.

FIG. 3 is a rear view of the hybrid energy storage device shown in FIG. 1.

FIG. 4 is a partially exploded perspective view of the hybrid energy storage device shown in FIG. 1.

FIG. 5 is a plan view of an insulating case in which the surface-mounted capacitors shown in FIG. 4 are arranged.

FIG. 6 is a plan view of the insulating case in which the surface-mounted capacitors shown in FIG. 4 are arranged.

FIG. 7 is a perspective view of the insulating case showing a state in which the surface-mounted capacitors shown in FIG. 4 are separated from the insulating case.

FIG. 8 is a perspective view of the insulating case showing a state where external terminal plates illustrated in FIG. 7 are separated from the insulating case.

FIG. 9 is a plan view of the insulating case shown in FIG. 8.

FIG. 10 is a rear view of the insulating case shown in FIG. 9.

FIG. 11 is a perspective view showing an exploded state of an electrode assembly and a cylindrical rubber member arranged inside the lead-type LTO battery shown in FIG. 4.

FIG. 12 is an equivalent circuit diagram of the hybrid energy storage device shown in FIG. 1.

### DETAILED DESCRIPTION OF THE INVENTION

Hereinafter, a hybrid energy storage device according to an embodiment of the present invention will be described with reference to the accompanying drawings.

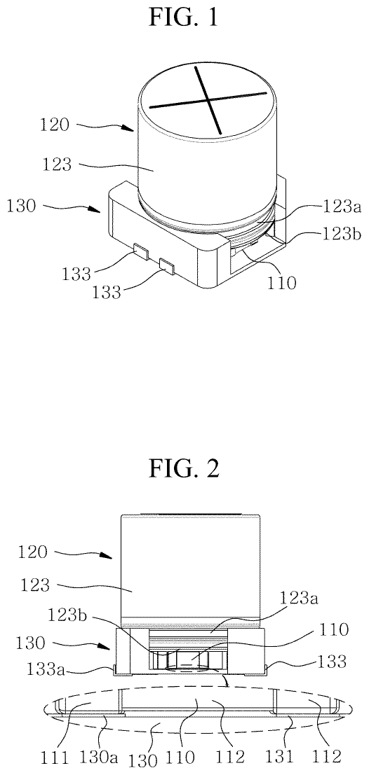

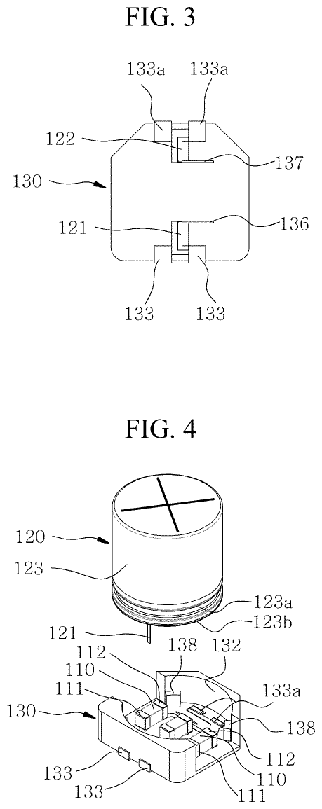

As shown in FIGS. 1 to 4, a hybrid energy storage device according to an embodiment of the present invention includes a surface-mounted capacitor 110, a lead-type lithium titanium oxide (LTO) battery 120, an insulating case 130, and a pair of external terminal plates 133 and 133a.

The surface-mounted capacitor 110 has a pair of external electrodes 111 and 112 formed on one side and the other side, respectively, and the lead-type LTO battery 120 has a pair of lead terminals 121 and 122. The insulating case 130 has a circular insertion groove 132 formed on one side surface thereof. A pair of metal connection patterns 130a and 131 are formed to be spaced apart from each other on the inside of the circular insertion groove 132. The pair of external terminal plates 133 and 133a are respectively arranged at one side and the other side of the insulating case 130 and are connected to the metal connection patterns 130a and 131, respectively.

The surface-mounted capacitor 110 is arranged inside the circular insertion groove 132, and the pair of external electrodes 111 and 112 are connected to the metal connection patterns 130a and 131, respectively. The lead-type LTO battery 120 is inserted into the circular insertion groove 132 so that the pair of lead terminals 121 and 122 are connected to the external terminal plates 133 and 133a, respectively. Thus, the surface-mounted capacitor 110 and the lead-type LTO battery 120 are connected to each other in parallel by the metal connection patterns 130a and 131 and the pair of external terminal plates 133 and 133a.

The hybrid energy storage device according to specific embodiments of the present invention is as follows.

One or more surface-mounted capacitors 110 are used. The one or more surface-mounted capacitors 110 have the external electrodes 111 and 112 formed on one side and the other side, respectively, One of a chip-type hybrid capacitor, a chip-type tantalum capacitor, and a multi-layer ceramic capacitor (MLCC) is used as each of the one or more surface-mounted capacitors 110.

Two or more surface-mounted capacitors 110 are used as shown in FIGS. 4 to 6, and each of the surface-mounted capacitors 110 may block wideband noise due to different frequency characteristics when using different capacitances.

The surface-mounted capacitor 110 prevents the lead-type LTO battery 120 arranged on the upper side of the surface-mounted capacitor 110 from being excessively protruded to the upper side of the insulating case 130 by using 1005 (10 mm×05 mm) to 5750 (57 mm×50 mm) size.

As shown in FIGS. 1, 2, 4, and 11, the LTO battery 120 includes the pair of lead terminals 121 and 122, a cylindrical hollow case 123, an insulating hollow bobbin 124, an electrode assembly 125, and a cylindrical rubber member 126.

The pair of lead terminals 121 and 122 each include one side thereof connected to one side of the electrode assembly 125, and the other side thereof protruding to the cylindrical rubber member 126 and are inserted into battery terminal insertion holes 136 and 137 to be connected to the external terminal plates 133 and 133a.

The cylindrical hollow case 123 includes a bead portion 123a having one side which is formed to be open to press a side surface of the cylindrical rubber member 126 at the one side thereof to seal the inner side thereof, and a curling portion 123b bent from an end of the bead portion 123a to press the cylindrical rubber member 126 along an edge of one side surface of the cylindrical rubber member 126 is formed.

The insulating hollow bobbin 124 is arranged inside the cylindrical hollow case 123, and the electrode assembly 125 is wound thereon.

The electrode assembly 125 is formed by sequentially laminating a positive electrode (not illustrated), a separator (not illustrated), a negative electrode (not illustrated), and an insulating film (not illustrated), and then winding the same on the insulating hollow bobbin 124. The positive electrode is formed by applying an LNMO (LiNi_{0.5}Mn_{1.5}O₄) electrode on the surface of a current collector (not shown), and the negative electrode is formed by applying an LTO (Li₄Ti₅O₁₂) electrode on the surface of the current collector (not shown).

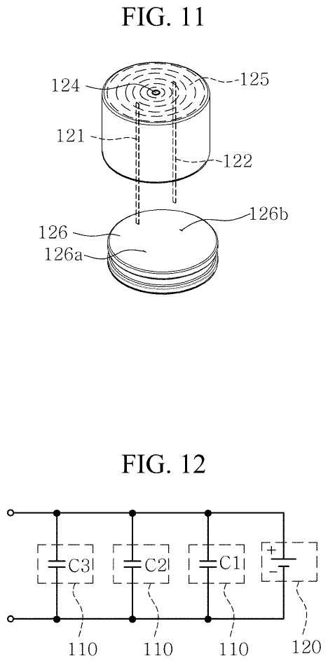

As shown in FIG. 11, the current collector having the LNMO (LiNi_{0.5}Mn_{1.5}O₄) electrode on the surface is connected to the lead terminal 121 among the pair of lead terminals 121 and 122, and the lead terminal 122 of the pair of lead terminals 121 and 122 is connected to the current collector in which the LTO (Li₄Ti₅O₁₂) electrode is formed on the surface.

The cylindrical rubber member 126 is connected to one side of the cylindrical hollow case 123 to be located on one side of the insulating hollow bobbin 124 to seal the inside of the cylindrical hollow case 123, and as shown in FIG. 11, a pair of insertion holes 126a and 126b into which the pair of lead terminals 121 and 122 are inserted are formed to be spaced apart from each other.

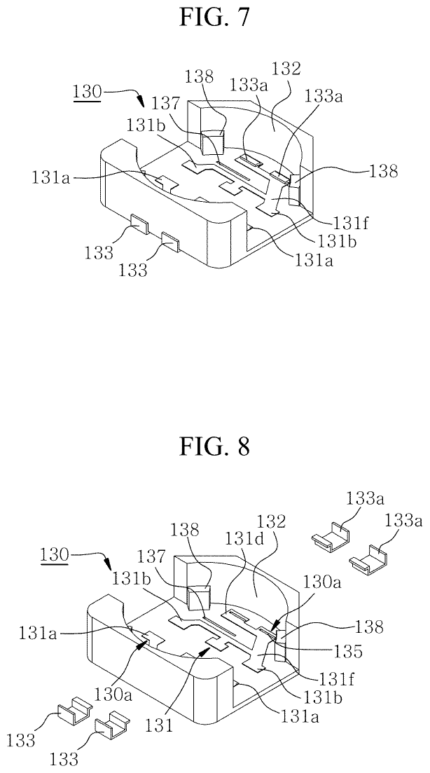

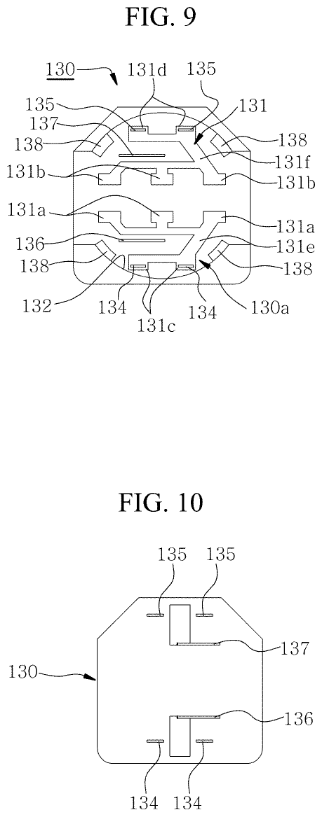

As shown in FIGS. 7 to 10, one side surface and the other side surface of the insulating case 130 are formed to be flat, and a circular insertion groove 132 into which the LTO battery 120 is inserted is formed on one side surface thereof. A pair of metal connection patterns 130a and 131 connected to the external electrodes 111 and 112 are formed inside the circular insertion groove 132, and a pair of external terminal insertion holes 134 and 135 into which the external terminal plates 133 and 133a are inserted are formed to be located inside the metal connection patterns 130a and 131, respectively. In addition, the insulating case 130 is spaced apart from the metal connection patterns 130a and 131, and a pair of battery terminal insertion holes 136 and 137 are formed, through which the lead terminals 121 and 122 are inserted to be connected to the external terminal plates 133 and 133a.

As shown in FIGS. 7 to 9, the pair of metal connection patterns 130a and 131b include a pair of external electrode connection patterns 131a and 131b, a pair of terminal plate connection patterns 131c and 131d, and a pair of wiring connection patterns 131e and 131f, respectively.

The pair of external electrode connection patterns 131a and 131b are formed to be spaced apart from each other on the inside of the circular insertion groove 132 to be connected to the external electrodes 111 and 112, and the pair of terminal plate connection patterns 131c and 131d are spaced apart from the external electrode connection patterns 131a and 131b, respectively, to surround the edges of the external terminal insertion holes 134 and 135 into which the external terminal plates 133 and 133a are inserted. The pair of wiring connection patterns 131e and 131f connect the external electrode connection patterns 131a and 131b with the terminal plate connection patterns 131c and 131d, respectively.

As shown in FIGS. 7 to 9, in the insulating case 130, a plurality of stoppers 138 supporting the LTO battery 120 inserted into the circular insertion groove 132 are in contact with and spaced apart from the inner peripheral surface of the circular insertion groove 132.

As shown in FIGS. 6 to 8, one side of each of the pair of external terminal plates 133 and 133a is inserted into the external terminal insertion holes 134 and 135 of the insulating case 130 to be connected to the metal connection patterns 130a and 131, and the other side thereof is extended to be in contact with the side surface of the insulating case 130 along the surface of the insulating case 130 to be inserted into the battery terminal insertion holes 136 and 137 of the insulating case 130 and to be connected to the other side of the lead terminals 121 and 122 bent along the surface of the insulating case 130.

A connection relationship of the hybrid energy storage device according to an embodiment of the present invention will be described below.

The surface-mounted capacitor 110 is mounted on the metal connection patterns 130a and 131 formed inside the circular insertion groove 132 of the insulating case 130 by soldering or the like.

In the surface-mounted capacitor 110, a pair of external electrodes 111 and 112 are mounted on a pair of external electrode connection patterns 131a and 131b of the metal connection patterns 130a and 131b by soldering or the like. For example, in the surface-mounted capacitor 110, when the external electrode 111 of the pair of external electrodes 111 and 112 is connected to the external electrode connection pattern 131a of the pair of external electrode connection patterns 131a and 131b, the external electrode 112 is connected to the external electrode connection pattern 131b.

The lead-type LTO battery 120 is inserted into the circular insertion groove 132 of the insulating case 130, and the pair of lead terminals 121 and 122 are inserted into the pair of battery terminal insertion holes 136 and 137 formed in the insulating case 130, respectively. The pair of battery terminal insertion holes 136 and 137 are formed to be spaced apart from the metal connection patterns 130a and 131 to be electrically insulated from the metal connection patterns 130a and 131, respectively.

The lead terminal 121 of the pair of lead terminals 121 and 122 is inserted into the battery terminal insertion hole 136 of the pair of battery terminal insertion holes 136 and 137, and the lead terminals 122 thereof is inserted into the battery terminal insertion hole 137, and then, both the lead terminals 121 and 122 are bent along the surface of the insulating case 130 so that the other sides are connected to the pair of external terminal plates 133 and 133a by soldering or the like. That is, the lead terminal 121 is connected to the external terminal plate 133 of the pair of external terminal plates 133 and 133a, and the lead terminal 122 is connected to the external terminal plate 133a.

The pair of external terminal plates 133 and 133a are inserted into the pair of external terminal insertion holes 134 and 135 formed in the insulating case 130, respectively, and each one side is connected to the pair of terminal plate connection patterns 131c and 131d by soldering or the like. For example, the external terminal plate 133 of the pair of external terminal plates 133 and 133a is inserted into the external terminal insertion hole 134 of the pair of external terminal insertion holes 134 and 135 to be connected to the terminal plate connection pattern 131c of the pair of terminal plate connection patterns 131c and 131d by soldering or the like. The external terminal plate 133a is inserted into the external terminal insertion hole 135 and one side thereof is connected to terminal plate connection pattern 131d of the pair of terminal plate connection patterns 131c and 131d by soldering or the like.

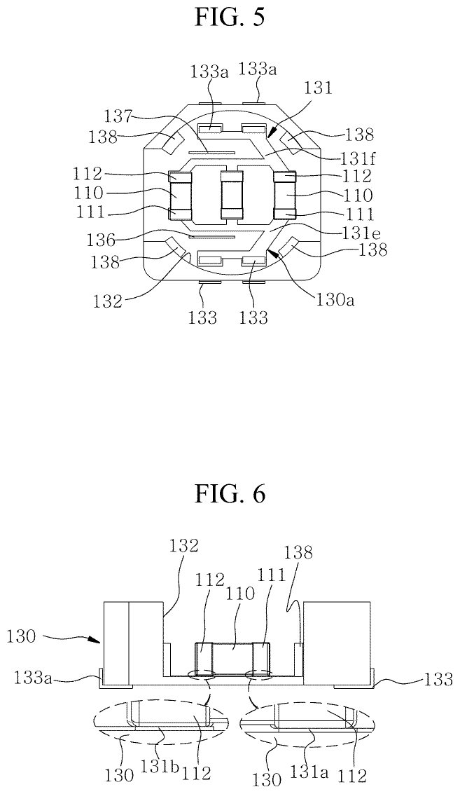

The pair of external terminal plates 133 and 133a and the pair of terminal plate connection patterns 131c and 131d are configured in two, respectively, as shown in FIGS. 5, 8, and 9, but each is connected to the pair of wiring connection patterns 131e and 131f to be electrically conducted.

In other words, the external terminal plate 133 and the terminal plate connection pattern 131c include two, respectively, but the two external terminal plates 133 are electrically connected to each other because the terminal plate connection pattern 131c is connected by the wiring connection pattern 131e. The external terminal plate 133a and the terminal plate connection pattern 131d include two, respectively, but the two external terminal plates 133a are electrically connected to each other because the terminal plate connection pattern 131d is connected by the wiring connection pattern 131f.

In the hybrid energy storage device according to an embodiment of the present invention, one LTO battery 120 and one surface-mounted capacitor 110 may be connected in parallel to each other through the metal connection patterns 130a and 131 as described above, and thus, During the overload output, the LTO battery 120 may prevent a rapid voltage drop at its own resistance due to a high current discharge, thereby preventing lowering of an output voltage and thus preventing reducing a life or causing a communication error due to an output overload of the LTO battery 120.

In the hybrid energy storage device according to another embodiment of the present invention, one LTO battery 120 and a plurality of surface-mounted capacitors 110 may be connected in parallel to each other through the metal connection patterns 130a and 131. For example, as shown in FIGS. 4 and 12, one LTO battery 120 and three surface-mounted capacitors 110 may be connected in parallel to each other.

As shown in FIG. 12, when the three surface-mounted capacitors 110 are applied, the three surface-mounted capacitors 110 having different capacitances C1, C2, and C3 and the lead-type LTO battery 120 may be connected in parallel to prevent broadband noise according to the frequency characteristics of the three surface-mounted capacitors 110.

The hybrid energy storage device of this invention has a capacity of 10 to 120 mAh for use in IoT, sensors and communication modules, has a rated voltage of 2.5 to 10 times the rated voltage of the LTO battery 120, and may be used in a wide temperature range of −55 to 125° C., in the case of use temperature ranges.

As described above, the hybrid energy storage device of the present invention is configured by connecting three surface-mounted capacitors 110 with different capacitances C1, C2, and C3 with one lead-type LTO battery 120 in parallel, thereby preventing broadband noise as well as supplying instantaneous high current pulses or density required by electronic devices (not shown) with instantaneous high output characteristics. When the lead terminal 121 of the pair of lead terminals 121 and 122 is connected to the positive electrode in which a LiNi_{0.5}Mn_{1.5}O₄ (LNMO) electrode is formed on the surface of a current collector (not shown), the lead terminal 122 is connected to the negative electrode in which the Li₄Ti₅O₁₂ (LTO) electrode is formed on the surface of the current collector (not shown) and thus, the lead-type LTO battery 120 is connected in parallel with three surface-mounted capacitors 110 with the different capacitances C1, C2, and C3.

The hybrid energy storage device of the present invention may output instantaneous high power and thus, may be used as a charge pump, may remove broadband noise by using three surface-mounted capacitors 110 with different capacitances C1, C2, and C3, and may stably supply power to devices used in harsh environments such as IoT, sensor devices, and communication equipment by the LTO battery 120.

The hybrid energy storage device according to the present invention has an advantage capable of easily mounting lithium titanium oxide (LTO) batteries and capacitors connected in parallel with each other by connecting the capacitors to the LTO batteries in parallel with each other and assembling the LTO batteries with the capacitors in one case.

In addition, the hybrid energy storage device according to the present invention may be used as a charge pump by preventing output power from being lowered due to the ESR characteristics of the LTO battery by compensating for power through capacitors during instantaneous high power discharge, thereby enabling instantaneous high power discharge.

In addition, the hybrid energy storage device according to the present invention has the advantage of expanding the range of use temperature while having sufficient energy storage density by using an LTO battery and improving surge characteristics through capacitors, thereby being used in a harsh environment such as IoT.

1. A hybrid energy storage device comprising:
a surface-mounted capacitor having a pair of external electrodes formed on one side and the other side thereof;
a lead-type lithium titanium oxide (LTO) battery having a pair of lead terminals connected thereto;
an insulating case having a circular insertion groove formed on one side thereof and a pair of metal connection patterns spaced apart from each other inside the circular insertion groove; and
a pair of external terminal plates arranged on one side and the other side of the insulating case, respectively, and having either side thereof connected to the metal connection pattern, wherein the surface-mounted capacitor is arranged inside the circular insertion groove so that each of the pair of external electrodes are connected to the metal connection pattern, and the lead-type LTO battery is inserted into the circular insertion groove so that the pair of lead terminals are connected to the external terminal plates, respectively.

2. The hybrid energy storage device of claim 1, wherein one or more surface-mounted capacitors are used, and the one or more surface-mounted capacitors are chip-type hybrid capacitors, chip-type tantalum capacitors, or multilayer ceramic capacitors (MLCC).

3. The hybrid energy storage device of claim 1, wherein two or more surface-mounted capacitors are used, and each has a different capacitance.

4. The hybrid energy storage device of claim 1, wherein the LTO battery comprises:
a cylindrical hollow case with one side open;
an insulating hollow bobbin arranged inside the cylindrical hollow case and on which an electrode assembly is wound;
a cylindrical rubber member connected to one side of the cylindrical hollow case to be located on one side of the insulating hollow bobbin to seal the inside of the cylindrical hollow case; and
a pair of lead terminals each having one side thereof connected to one side of the electrode assembly, and the other side thereof protruding to the cylindrical rubber member and inserted into a battery terminal insertion hole to be connected to an external terminal plate, and
the cylindrical hollow case comprises: a bead part formed on one side to seal the inside by pressing a side surface of the cylindrical rubber member; and a curling part bent at an end of the bead part to press along the edge of one side surface of the cylindrical rubber member.

5. The hybrid energy storage device of claim 4, wherein
the electrode assembly is formed by sequentially stacking a positive electrode, a separator, a negative electrode, and an insulating paper, and then winding same around an insulating hollow bobbin,
the positive electrode is a LiNi_{0.5}Mn_{1.5}O₄ (LNMO) electrode, and
the negative electrode is a Li₄Ti₅O₁₂ (LTO) electrode.

6. The hybrid energy storage device of claim 1, wherein the insulating case has one side surface and the other side surface which are formed flat, and comprises:
a circular insertion groove into which the LTO battery is inserted and which is formed on the one side surface of the insulating case;
a pair of external terminal insertion holes into which the external terminal plates are inserted, respectively, so as to be positioned inside the metal connection pattern; and
a pair of battery terminal insertion holes which are spaced apart from the metal connection pattern and into which the lead terminals are inserted, respectively.

7. The hybrid energy storage device of claim 6, wherein each of the pair of metal connection patterns comprises:
a pair of external electrode connection patterns formed on the inner side of the circular insertion groove to be spaced apart from each other and to which external electrodes are respectively connected;
a pair of terminal plate connection patterns spaced apart from the external electrode connection patterns and formed to surround edges of the external terminal insertion holes into which the external terminal plates are inserted and
a pair of wiring connection patterns connecting the external electrode connection pattern and the terminal plate connection pattern to each other.

8. The hybrid energy storage device of claim 6, wherein the insulating case comprises a plurality of stoppers for supporting the LTO battery inserted into the circular insertion groove, the plurality of stoppers being in contact with an inner circumferential surface of the circular insertion groove and being spaced apart from each other.

9. The hybrid energy storage device of claim 1, wherein
one side of each of the pair of external terminal plates is inserted into the external terminal insertion hole of the insulating case to be connected to the metal connection pattern, and
the other side thereof is extended in contact with the side surface of the insulating case along the surface of the insulating case to be inserted into the battery terminal insertion hole of the insulating case and connected to the other side of the lead terminal bent along the surface of the insulating case.
